(19) United States
(12) Patent Application Publication
(10) Pub. No.: US 2026/0348359 A1
(43) Pub. Date: Nov. 5, 2026

(54) Air Flow Turbine Generator for Placement on a Moving Vehicle

(71) Applicant: John L. KNIFFEN, San Antonio, TX (US)

(72) Inventor: John L. KNIFFEN, San Antonio, TX (US)

(21) Appl. No.: 19/194,233

(22) Filed: Apr. 30, 2025

(51) Int. Cl. F03D 9/25; F03D 9/32

(52) U.S. Cl. CPC F03D 9/25; F03D 9/32; F05B 2220/706; F05B 2240/941

(57) ABSTRACT

Systems are described for generating power from air flow utilizing an array of turbine power generators positioned on a moving vehicle. The system utilizes uniquely configurable air foil turbine wings positioned on rotors directed into the flow of air. The air foils vary not only in pitch but also in cross-section to gain maximum lift (translated into to rotational torque) for a given platform speed. The individual air foils include sharp, knife-line, leading and trailing edges for the wings, partially constrained front and rear stabilizing springs that control compression of the upper wing surface, mid-wing stabilizing tension spring that controls expansion of the upper wing surface, and pitch modulation controlled by the combination of a main rod with bearing that attaches the wing to the rotor shaft and a rear rod with a preferencing spring positioned and movable within a slot that allows for a limited vertical motion.

### BACKGROUND OF THE INVENTION

The present invention relates generally to systems and methods for generating power from wind and/or moving air. The present invention relates specifically to a turbine power generator system positioned on a moving vehicle to harness the energy in the air flow around the vehicle. The system utilizes uniquely configurable air foil turbine wings positioned on rotors having rotation directed into the flow of air.

### DESCRIPTION OF THE RELATED ART

Efforts have been made in the past for vehicle based air flow power generators. Examples of these efforts include: U.S. Pat. No. 7,135,786, issued to Deets, entitled Wind Driven Generator for Powered Vehicles; U.S. Pat. No. 10,598,153, issued to Dietzel, entitled Power Generation Architecture Using Environmental Fluid Flow; and U.S. Pat. No. 11,187,207, issued to Perkins, entitled Airfoil-Based Air Turbine; the full disclosures of which are incorporated herein by reference. Most prior efforts have utilized fan blades as opposed to air foils, making the movement of the vehicle through the air flow more difficult resulting in a reduced translation of the kinetic energy of motion into electrical power.

### SUMMARY OF THE INVENTION

The present invention provides systems and methods for generating power from wind and/or moving air that utilizes an array of one or more turbine power generators positioned on a moving vehicle to harness the energy in the air flow around the vehicle. The system utilizes uniquely configurable air foil turbine wings positioned on rotors having rotation directed into the flow of air. The key elements of the invention include: the placement of system on a moving vehicle as opposed to a land based system; the rotation of the system (i.e. the orientation of the axis of rotation) directed into the air flow as opposed to having the axis of rotation transverse to the flow; and the configurable wing structure comprising an air foil as opposed to a fan blade (flat, curved, or hybrid) or as opposed to a paddle wheel/squirrel cage driven rotor.

The device of the present invention consists of a winged wind rotor (WWR) and is intended to be mounted or attached on moving platforms such as vehicles, trains, and small aircraft such as drones. The Winged Wind Rotor (WWR) is to be set up to turn on a central shaft in a given direction defined by the typical forward movement of the platform and powered by strong winds provided by the movements of the accompanying attached platform. The number of wings attached to the central shaft should be at least two, however, the maximum number would depend on the length and shape of the wings as well as the overall diameter of the Winged Wind Rotor unit. The air foils themselves are designed to vary not only in pitch but also in cross-section to gain maximum lift (translated into to rotational torque) for a given platform speed. One or more generators may be positioned inline with the WWR or in parallel driven by appropriate arrangements of gears, belts, or other rotational transmissions.

The individual air foils incorporate four significant features that improve operational power generation efficiency. First, the air foils include sharp, knife-line, leading edges for the wings as well as sharp trailing edges for the wings. Second, the cross-sectional configuration of the air foils is partially constrained by front and rear stabilizing springs that control downward compression of the upper wing surface. Third, the cross-sectional configuration of the air foils is additionally constrained by a mid-wing stabilizing spring that, under tension, controls an upward expansion of the upper wing surface. Fourth, the pitch of the wing is controlled by a combination of a main rod with bearing that allows for attachment of the wing to the central rotor shaft and a rear rod with a preferencing spring positioned and movable within a slot that allows for a limited vertical motion to the wing (change in pitch).

### BRIEF DESCRIPTION OF THE DRAWINGS

FIG. 1 is a schematic perspective view (from the front) of an exemplary winged wind rotor (WWR) of the present invention with an array of six air foils directed into the air flow as shown.

FIG. 2 is a schematic perspective view (from the back) of an exemplary bank of six winged wind rotor (WWR) assemblies of the present invention arranged along a common rotor shaft with aligned air foils forming smooth air flow paths as shown.

FIG. 3 is a side plan view of an array of winged wind rotor (WWR) assemblies positioned on and secured to an orientation framework structured on a typical moving vehicle (a pickup truck in this instance).

FIG. 4 is a top plan view of two linear arrays of winged wind rotor (WWR) assemblies positioned on and secured to an orientation framework structured on a typical moving vehicle (as shown in FIG. 3).

FIG. 5 is a front plan view of two linear arrays of winged wind rotor (WWR) assemblies positioned on and secured to an orientation framework structured on a typical moving vehicle (aa shown in FIGS. 3 & 4).

FIG. 6 is a detailed cross-sectional view of an exemplary air foil of the present invention disclosing the various structural innovations to improve the efficiency of the lift forces translated into rotational torque.

FIG. 7 is a detailed cross-sectional view of an exemplary air foil of the present invention disclosing the sharp knife-line leading edge of the wing structure.

FIG. 8 is a detailed side view of an exemplary air foil of the present invention disclosing the positioning of the main rod and the rear rod that operate together to alter the pitch of the wing depending on variations in operational conditions.

FIG. 9 is a detailed schematic view of the rear rod with preferencing spring positioned in a oval aperture in the rear of the wing that allows for limited vertical motion of the rear section of the wing.

FIG. 10 is a detailed cross-sectional view of an exemplary air foil of the present invention disclosing the internal spring structures within the middle and rear sections of the wing that assist in controlling the compression and expansion of the upper wing surfaces.

FIG. 11 is a detailed cross-sectional view of an exemplary air foil of the present invention disclosing the sharp trailing edge of the wing structure and the internal compression control spring.

FIG. 12 is a detailed cross-sectional view of an exemplary air foil of the present invention disclosing the sharp leading edge of the wing structure and the internal compression control spring.

FIG. 13 is a detailed front cross-sectional view of an exemplary embodiment of the present invention showing the wing side panels and associated bearings fitted onto the main rod of the winged wind rotor (WWR).

FIG. 14 is a top plan view of an exemplary air foil of the present invention disclosing the generally rectangular shape of the upper surface of the air foil with leading and trailing edges shown and disclosing the placement of stabilizing side braces.

FIG. 15 is a side view of an exemplary air foil of the present invention shown in FIG. 14 again disclosing the placement of stabilizing side braces.

### DETAILED DESCRIPTION

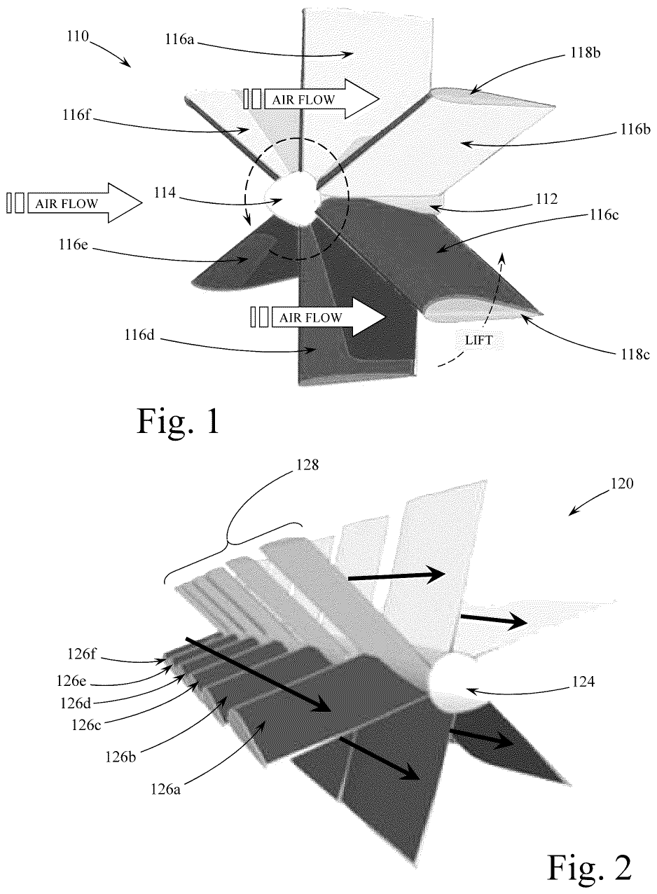

Reference is made first to FIG. 1 which is a schematic perspective view (from the front) of an exemplary winged wind rotor (WWR) of the present invention with an array of six air foils directed into the air flow as shown.

The primary purpose of the wing design is to use lift created by air flow over the wing surface while creating the least possible amount of drag or resistance on the air flow moving around it. The goal is to create the highest ratio possible between the torque generated on the central shaft and the air flow resistance on the device itself. The use of wings allows the device to be powered by winds of approximately 40 mph to more than 100 mph. The maximum air speed for a winged wind rotor will depend on the materials used in its construction as well as the characteristics built into the wing design.

Four possibly unique alterations to the typical or standard wing design have been incorporated into the Winged Wind Rotor wing design.

(a) The first alteration is the construction of a sharp knife-like leading edge on the front of the wing. Its purpose is to split the air as efficiently as possible to reduce the drag force of the wind on the front area or leading edge of the wing.

(b) The second alteration is the construction of a knife-like edge on the trailing edge of the wing to reduce drag producing convection at the rejoining of the two air flows.

(c) The third alteration is the construction of a spring-controlled device within the body of the wing to allow rotation of the wing while in motion. This will allow the bottom surface of the wing to rotate toward a flattened or parallel condition with the wind thereby reducing unnecessary drag caused by the combination of high wind speeds and the original upward slope of the lower wing surface.

(d) The fourth alteration is the construction of a spring-controlled slip-surface in the rear area of the upper wing surface. The purpose is to allow the upper wing to compress to a more flattened condition at high wind speeds further reducing drag on the wing and possibly reducing over rotation of the Winged Wind Rotor when encountering higher than expected wind speeds.

As stated above, the Winged Wind Rotor is expected to be attached to multiple platforms. In doing so, care should be taken with respect to minimizing the effect of air drag on the leading and trailing edges on all framing surfaces of its construction as well as keeping its final gross weight as low as possible.

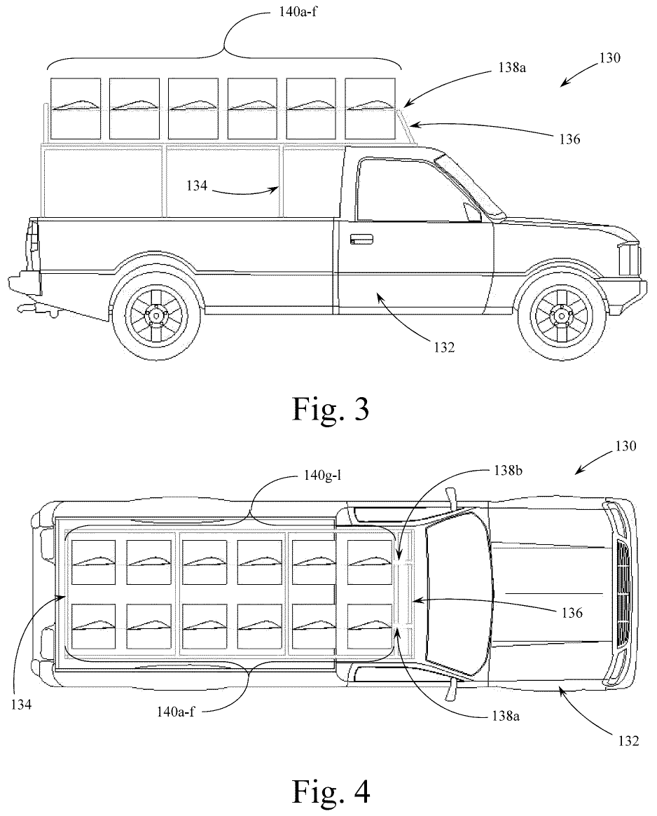

FIG. 1 presents a generalized overall view of a six-winged set up on a central shaft. It doesn't indicate any of the unique features described in the following details. The number of Winged Wind Rotor's mounted on the shaft will depend on the space available on the accompanying platform (see FIGS. 3-5) . The number of wings within each Winged Wind Rotor unit will depend on the diameter of the unit or the length of the wings and design recommendations of the aeronautical engineer stemming from the platform to which it is to be attached. In FIG. 1, WWR 110 is seen to include an array of air foils 116a-116f positioned on rotor shaft 112 having a conical end 114 facing into the air stream. Air foil side end panels 118a-118f disclose the air foil wing configuration (without all of the configuration improvements of the present invention).

FIG. 2 is a schematic perspective view (from the back) of an exemplary bank 120 of winged wind rotor (WWR) assemblies 128 of the present invention arranged along a common rotor shaft 124 with aligned air foils 126a-126f forming smooth air flow paths as shown. This figure indicates the ability of multiple winged wind rotors 128 being placed directly in line and on a single shaft 124. The air that passes through the first unit will also power the second, the third and so on. Air foils could be installed between units to ensure the same airflow is maintained throughout its length.

FIG. 3 is a side plan view of an installation 130 on a vehicle including a first array of winged wind rotor (WWR) assemblies 140a-140f positioned on and secured to an orientation framework 134 structured on a typical moving vehicle 132 (a pickup truck in this instance). The front 136 of framework 134 is angled to accommodate the incoming air flow around front of the rotor shafts 138a & 138b.

FIG. 4 is a top plan view of the installation 130 shown in FIG. 3 disclosing two linear arrays of winged wind rotor (WWR) assemblies 140a-140l (140a-140f and 140g-140l) positioned on and secured to an orientation framework 134 structured on a typical moving vehicle 132 (again as shown in FIG. 3).

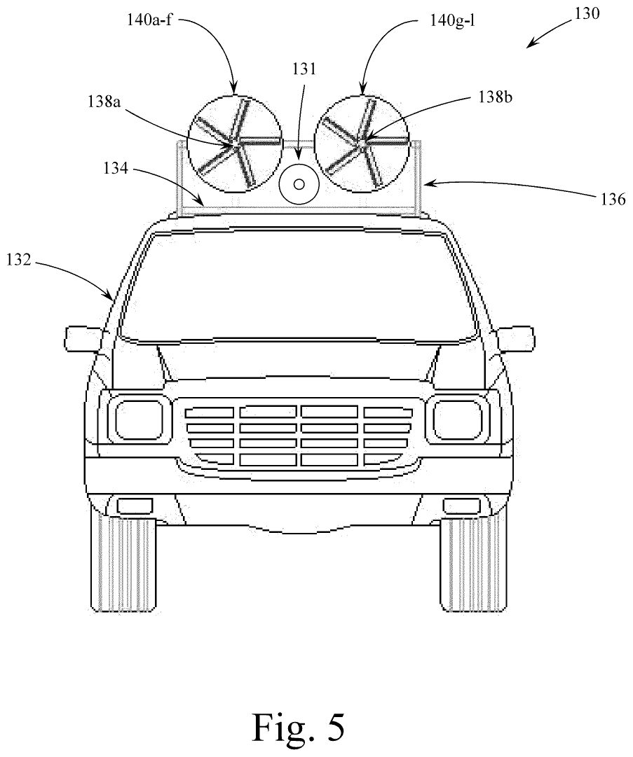

FIG. 5 is a front plan view of the installation 130 shown in FIGS. 3 & 4 disclosing two linear arrays of winged wind rotor (WWR) assemblies 140a-140f and 140g-140l positioned on and secured to an orientation framework 134 structured on a typical moving vehicle 132 (again as shown in FIGS. 3 & 4).

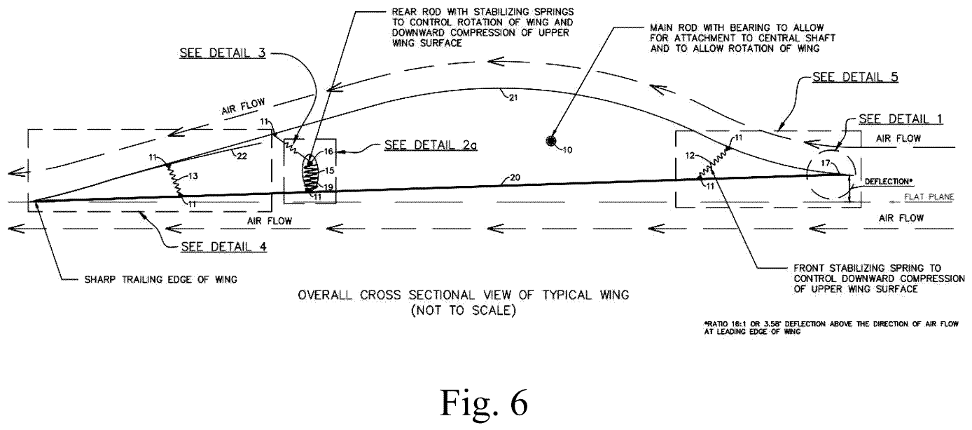

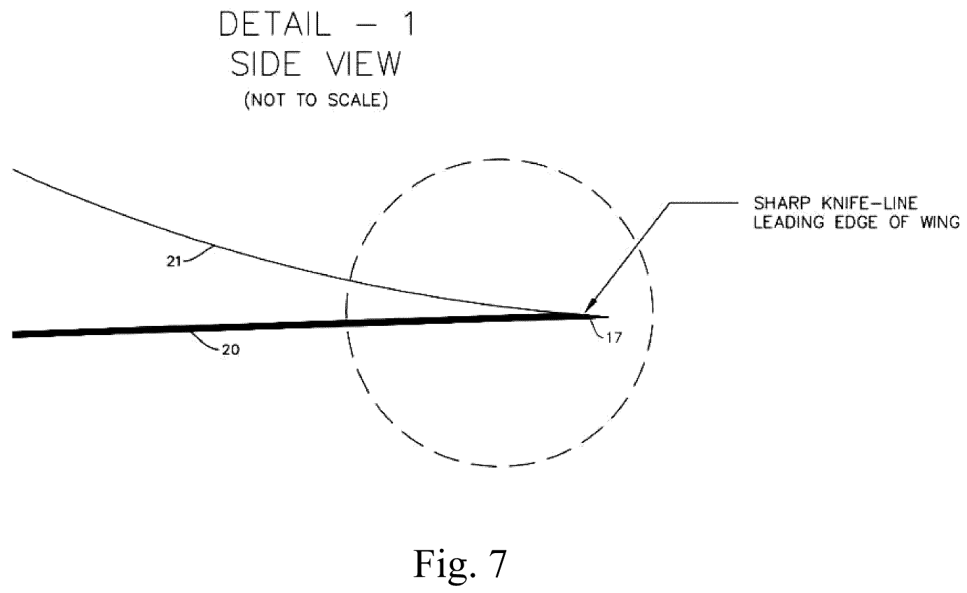

Reference is next made to FIG. 6 which presents an overall cross-sectional view of a typical wing and the intended air flow direction. FIG. 6 indicates the approximate locations for the main and rear support rods 10 & 16 as well as the approximate locations for the tension and compression springs. It also indicates the upward tilt of the front edge of the wing at a 16 to 1 ratio or an approximate 3.58 degree slope. This upward tilt is intended to assist the Winged Wind Rotor (WWR) at low air speeds. This FIG. 6 also indicates the locations of Details 1-5 (See FIGS. 7-15) which provide further descriptions of the improved features of the air foil design of the present invention.

FIG. 7 (Detail 1) represents a cross-sectional view of the leading or front edge of a wing. To reduce friction from the wind in this area of the wing it should be constructed with a sharp knife-like leading edge 17. This should allow the oncoming air flow to split with very little resistance or drag on the upper 21 and lower 20 wing surfaces.

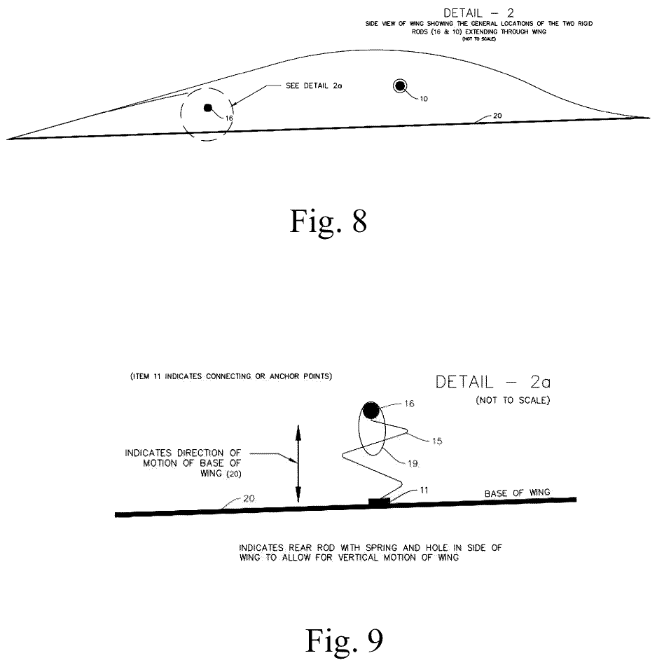

FIG. 8 (Detail 2) represents a cross-sectional view of the location of the Winged Wind Rotor front main support rod 10 that is to be anchored to the central rotor shaft of the system and will provide the primary support for the wing. To allow for rotational movement of the wing on the support rod 10, saddle block type bearings, or equivalent, are to be installed between the rod and both the inside and outside panels of the wing. The support rod should be centrally located within the body of the wing and be strong enough to support the expected centrifugal forces subjected to the wing during rotation. FIG. 8 also indicates the general location of a second support rod 16. This rod is also to be anchored to the central shaft of the Winged Wind Rotor and will provide a point of control for the rotational movement of the body of the wing around the main support rod 10.

FIG. 9 (Detail 2a) represents a detailed view of the spring 15 that is to be connected between the rear support rod 16 and the lower wing panel 20 at attachment 11. FIG. 9 also indicates an oblong hole 19 that is to be located on the side panel 25 of the wing. The length of the hole should be sufficient to allow the lower wing surface 20 to rotate upward to a horizontal or parallel to the wind condition when wind speeds exceed a set velocity. This should allow for a further reduction of the air flow resistance to the Winged Wind Rotor unit. At least two equally spaced compression springs 15 are to be installed in the body of the wing between the support rod 16 and the base of the wing 20.

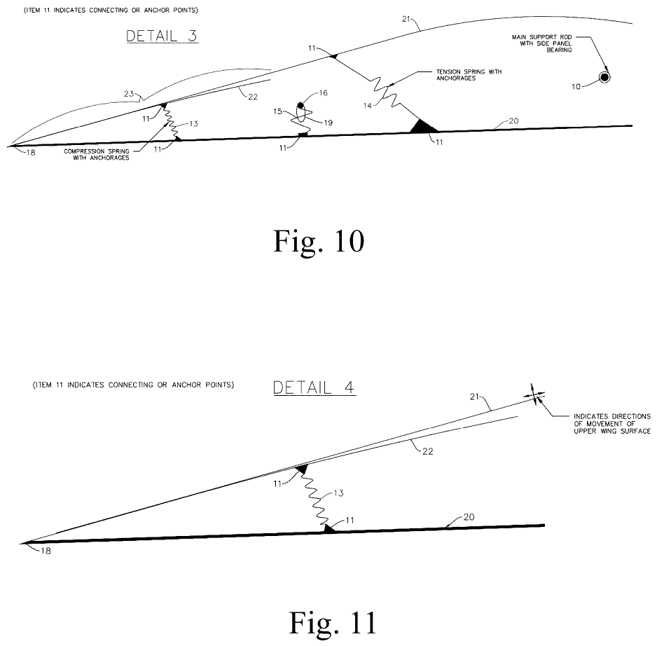

FIG. 10 (Detail 3) represents a cross sectional view of a wing showing the approximate location of the slip surface 23 between upper wing surfaces 21 & 22 and the controlling springs 13 & 14 and anchor locations 11. The slip surface will be dependent on the flexibility of the upper wing material as well as the internal supporting springs 13 & 14. FIG. 10 also shows the trailing edge of the wing 18. Like the front edge 17 this edge should be a sharp knife-like edge to reduce convection at the connection of the two moving air flows.

FIG. 11 (Detail 4) represents a cross-sectional view of the compression spring 13 located between the rear support rod and the lower wing surface. There should be a minimum of two compression springs designed to allow for the controlled rotation of the body of the wing on the main support rod. The range of movement and strength of the springs used are defined by associated wind tunnel testing and engineering requirements.

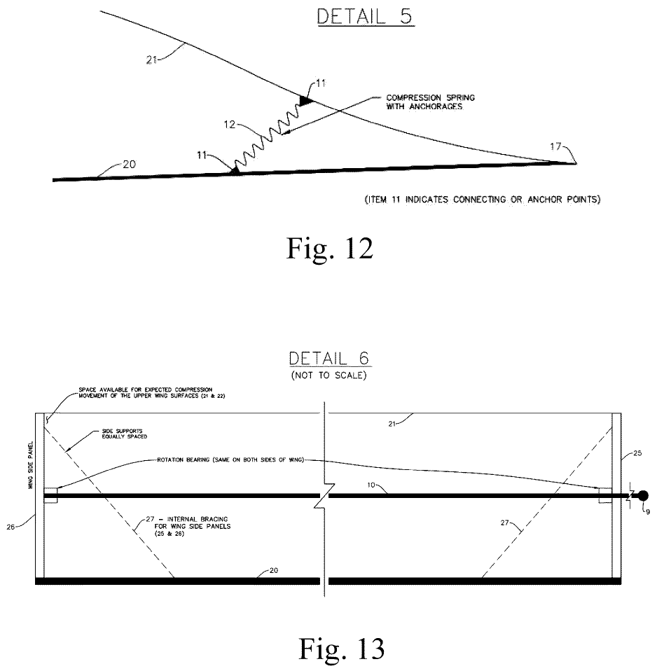

FIG. 12 (Detail 5) This figure represents a cross-sectional view of a compressional spring 12 that is to be located between the upper wing 21 and the base of the wing 20 in the area of the front slope behind the leading edge 17. The purpose is to allow for compression or flattening of the upper wing surface during periods of high wind velocities. This will reduce air flow resistance and may also help to prevent damage to the Winged Wind Rotor system when encountering unexpected strong winds. At least two compressional springs 12 are to be equally spaced across the wing using anchor points 11.

FIG. 13 (Detail 6) represents a front view of wing side panels 25 & 26 that are to be located on each side of the body of the wing. Their purpose is to prevent wind from entering into the open space inside of the wing. An arcuate side slot is to be located on the inside side panel 25 where the rear support rod 16 is located to allow for vertical movement of the wing body (see FIG. 9). This opening should be as small as possible and designed to prevent moving outside air from entering the cavity of the wing and creating convection and/or friction while in operation.

To allow for the compressional movement of the upper wing surfaces 21 & 22 the space at the top of both side panels 25 & 26 should be designed to be very smooth or frictionless. The leading top edge of both side panels should be tapered on the outside to a sharp edge to prevent wind resistance.

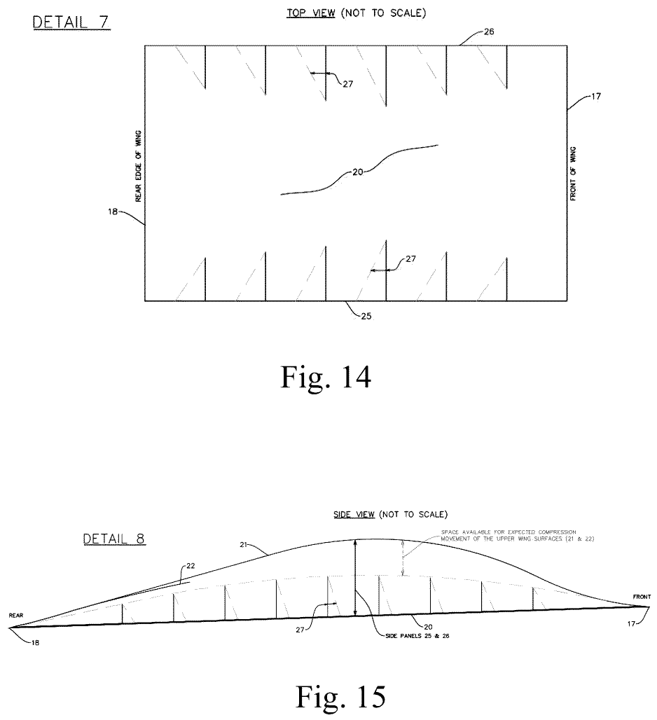

FIGS. 14 & 15 (Details 7 & 8) indicate the internal side panel braces 27 that are to be located at roughly equal spacing along both side panels. They should be designed strong enough to prevent inward or outward movements of the side panels 25 & 26 during the expected rotational speeds of the Winged Wind Rotor and be of minimal weight. A space between the top of the braces and the top of the side panels should be created to allow for compressional movement of the upper wing surfaces 21 & 22 as described in FIG. 12.

Although the present invention has been described in conjunction with a number of exemplary embodiments, those skilled in the art will recognize modifications to these embodiments that still fall within the scope of the present invention. Various numbers of WWR assemblies arranged in linear arrays are anticipated, dependent in part on the size and configuration of the vehicle to which the arrays are secured. Additional air flow funnels, ducting, and channels may preferably be configured around and between the WWR arrays. Various single and multiple generator arrangements are also anticipated. Various energy storage devices (batteries, etc.) are also anticipated, some of which might operate in conjunction with the drive system of the vehicle. Each of these modifications and additional structural features are anticipated to fall within the spirit and scope of the present invention.

1. A system for generating electrical energy from a flow of air developed in association with a moving vehicle, the flow of air defining an air flow direction, the system entirely configured on the moving vehicle and comprising:
one or more turbine rotors, each turbine rotor comprising a rotor shaft and a plurality of aerodynamic wings radially positioned and radially oriented on the rotor shaft, each aerodynamic wing having a leading edge oriented generally into the flow of air and perpendicular to the turbine rotor shaft, each aerodynamic wing further having a trailing edge and a length, each aerodynamic wing oriented to rotate the rotor in a specific direction; and
at least one electrical generator, the generator comprising an alternator with a stator and a generator rotor, the generator rotor rotationally coupled to the one or more turbine rotors.

2. The system of claim 1 wherein the generator rotor is rotationally coupled to the one or more turbine rotors through at least one mechanical linkage.

3. The system of claim 1 wherein the at least one electrical generator comprises an electrical output and the system further comprises an electrical storage device connected to the generator electrical output.

4. The system of claim 1 wherein the leading edge of each aerodynamic wing comprises a sharp knife edge configuration.

5. The system of claim 1 wherein the trailing edge of each aerodynamic wing comprises a sharp knife edge configuration.

6. The system of claim 1 wherein each of the aerodynamic wings is movably attached to the turbine rotor through a main rod and a rear rod, the main rod and the rear rod each oriented parallel to the leading edge of the associated aerodynamic wing.

7. The system of claim 6 wherein the main rod extends the length of the aerodynamic wing between the leading edge and the trailing edge of the wing and is configured to allow the aerodynamic wing to pivot around the main rod.

8. The system of claim 7 wherein the rear rod extends the length of the aerodynamic wing between the main rod and the trailing edge of the wing and is configured as a soft connection to allow the aerodynamic wing to translate across the rear rod as the aerodynamic wing pivots around the main rod.

9. The system of claim 8 wherein the movable attachment of the aerodynamic wing to the rear rod further comprises a stabilizing spring to control the pivoting rotation of the wing.

10. The system of claim 6 wherein the aerodynamic wing further comprises at least one internal front stabilizing compressional spring positioned at a location between the leading edge and the main rod to control downward compression of an upper wing surface.

11. The system of claim 6 wherein the aerodynamic wing further comprises an internal rear stabilizing compressional spring positioned at a location between the trailing edge and the rear rod to control downward compression of an upper wing surface.

12. The system of claim 1 further comprising a mounting frame for securing all components of the system to an external air flow surface of the moving vehicle, and wherein the one or more turbine rotors comprises at least two turbine rotors mounted adjacent to each other in a front portion of the frame unobstructed from an incoming air flow.

13. The system of claim 1 further comprising a mounting frame for securing all components of the system to an external air flow surface of the moving vehicle, and wherein the one or more turbine rotors comprises at least two turbine rotors mounted inline with each other on the frame and share a rotor shaft, whereby air flows through a first turbine rotor and then through the second turbine rotor.

14. The system of claim 12 wherein the at least one electrical generator comprises at least two electrical generators each connected separately to the rotor shaft of the associated one of the at least two turbine rotors.

15. The system of claim 13 wherein the at least one electrical generator comprises a single electrical generator connected with the shared rotor shaft of the at least two turbine rotors.
